(19) United States
(12) Patent Application Publication
(10) Pub. No.: US 2014/0049897 A1
(43) Pub. Date: Feb. 20, 2014

(54) STORAGE CARRIER APPARATUS AND METHOD FOR SUPPORTING STORAGE DEVICES OF DIFFERENT TRANSVERSE DIMENSIONS WITHIN A COMMON PLATFORM

(71) Applicants: Shawn Hoss, Austin, TX (US); Matthew McGuff, Austin, TX (US)

(72) Inventors: Shawn Hoss, Austin, TX (US); Matthew McGuff, Austin, TX (US)

(73) Assignee: Dell Products L.P., Round Rock, TX (US)

(21) Appl. No.: 13/589,403

(22) Filed: Aug. 20, 2012

(51) Int. Cl. G06F 1/16

(52) U.S. Cl. 361/679.31

(57) ABSTRACT

A storage assembly, system, and method provide a common platform that supports storage devices of different transverse dimensions. The storage assembly comprises a first storage device compactly disposed in a first storage carrier. The first storage device has a transverse dimension (e.g., a width) that is larger than that of second storage devices specifically designed to be compactly coupled to the common platform via an array of connectors. The storage device further comprises an interposer assembly coupled to a data interface of the first storage device. When the first storage carrier is placed for coupling the first storage device to an opposing connector of the array of connectors, the interposer assembly is disposed between the first storage device and the opposing connector to cause the first storage device to be displaced laterally away from an adjacent connector while coupling the first storage device to the opposing connector.

### BACKGROUND

1. Technical Field

The present disclosure generally relates to an information handling system and in particular to a storage carrier apparatus and method for providing a common platform in an information handling system to support storage devices of different transverse dimensions.

2. Description of the Related Art

As the value and use of information continue to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

An information handling system (IHS), such as a computer system, may include a plurality of storage devices, such as hard disk drives (HDDs), each coupled to a backplane of the IHS via a backplane connector. As technologies advance, there has been a trend to decrease the physical sizes/dimensions of storage devices, while increasing the capacity and/or storage densities of the storage devices. Thus, for example, the densities of solid state drives (SSD) have continued to increase, commensurate with a decrease in one or more transverse dimensions of SSDs. As a specific example of this trend, 7 mm SSDs and backplanes supporting these 7 mm 2.5″ SSDs have become the standard drive sizes, replacing the traditional 15 mm 2.5″ SSDs and supporting backplanes. A 7 mm SSD (i.e., an SSD which is typically 7.5 mm or less in width or thickness) is about one half in width or thickness when compared to the conventional 15 mm 2.5″ SSD, while providing as much storage as, and in some instances greater storage capacity than, the 15 mm width SSD.

Manufacturers embrace a smaller double density 7 mm 2.5″ HDD, such as 7 mm 2.5″ SSD, by manufacturing IHSs with a backplane having double dense SAS connectors configured for coupling 7 mm 2.5″ SSDs to the backplane. With the double density backplane, a 15 mm 2.5″ SSD cannot be coupled to the backplane as the drive's greater width causes the drive to abut one or more adjacent double dense SAS backplane connectors, which prevents the coupling of the drive's data interface to an opposing backplane connector.

Occasionally, for an IHS built and configured to support storage devices of a higher density and a smaller size, a user may wish to use storage devices of a lower density in such an IHS due to cost consideration and other factors. For example, a user may wish to re-use previously purchased 15 mm 2.5″ SSDs either exclusively or in conjunction with the double density 7 mm 2.5″ SSDs in an IHS with a double density backplane. However, with an IHS that provides the double density backplane, the user would be forced to either have the old 15 mm 2.5″ SSDs externally installed or use an older system with single density backplane to transfer data to the new 7 mm 2.5″ SSDs and completely abandon the old 15 mm 2.5″ SSDs.

One obvious approach to address this issue is adding to the IHS a separate single density backplane. Alternately, the backplane and/or the chassis of the IHS may be modified to support individual 15 mm 2.5″ SSDs. These approaches, however, will inevitably increase backplane and chassis complexity of an IHS, thereby increasing the manufacturing cost thereof.

### BRIEF SUMMARY

Disclosed are a storage assembly, system and method for providing a common platform in an information handling system (IHS) to support storage devices of different transverse dimensions. The storage assembly comprises: a first storage device having a data interface for coupling the first storage device to an opposing connector within an array of connectors of an information handling system; and an interposer assembly coupled to the data interface of the first storage device such that the interposer assembly is disposed between and enables coupling of the first storage device to the opposing connector when the first storage device is positioned for coupling to the opposing connector. The interposer assembly causes the first storage device to be displaced laterally away from an adjacent connector of the array of connectors without causing any physical contact with the adjacent connector, while allowing the first storage device to be physically and communicatively coupled to the opposing connector. Also, the first storage device has a transverse dimension which is larger than a corresponding transverse dimension of second storage devices that are specifically designed to compactly couple to adjacent connectors of the array of connectors. Accordingly, a cross spacing available for directly coupling to the adjacent connectors is smaller than the transverse dimension of the first storage device.

According to one aspect, the storage assembly further comprises: a first storage carrier within which the first storage device is physically secured at a first position that provides sufficient spacing at a coupling end of the first storage device for coupling the interposer assembly to the data interface of the first storage device without extending an overall length of the storage assembly. The interposer assembly is positioned in a connecting end of the first storage carrier that is physically proximate to an opposing connector and an adjacent backplane connector array when the first storage carrier is disposed for coupling of the first storage device to the opposing connector. Also, the connecting end of the storage assembly has a corresponding transverse dimension that is substantially close to the transverse dimension of the first storage device. The array of connectors are physically configured to allow an array of second storage devices to compactly couple thereto such that the transverse dimension of each individual space allocated between adjacent connectors is smaller than the transverse dimension of the first storage carrier. In one or more embodiments, the transverse dimension of the first storage device is larger than the corresponding transverse dimension of the second storage devices by a proportional size that allows each first storage device to extend across at least one adjacent connector, while coupled to the opposing connector.

According to one aspect of the disclosure, disclosed is a storage assembly comprising a first storage device compactly disposed in a first storage carrier, with the first storage device having the size of at least one transverse dimension being larger than the size of the similar dimension of a second storage device. The storage assembly further comprises an interposer assembly coupled to a data interface of the first storage device such that the interposer assembly is positioned in a space of the first storage carrier that is physically proximate to an opposing connector and an adjacent connector of an array of connectors when the first storage carrier is placed for coupling the first storage device to the opposing connector. The interposer assembly is disposed between the first storage device and the opposing connector to cause the first storage device to be displaced laterally away from the adjacent connector while allowing the first storage device to be physically and communicatively coupled to the opposing connector without causing any physical contact with the adjacent connector. The array of connectors are physically configured to allow an array of second storage devices to compactly couple to the individual connectors; However, the transverse size of each individual space allocated for coupling is smaller than the transverse dimension of the first storage carrier.

According to another aspect of the disclosure, disclosed is a system that provides a common platform in an information handling system (IHS) to simultaneously support a first storage device and a second storage device with the size of one transverse dimension of the first storage device being bigger/larger than the size of the same transverse dimension of the second storage device. The system includes a first storage assembly comprising a first storage device compactly disposed in a first storage carrier with the first storage device having the size of a transverse dimension that is bigger than the size of the same dimension of each second storage device. The first storage assembly further comprises an interposer assembly coupled to a data interface of the first storage device. The system further comprises the information handling system having an array of connectors physically configured to allow an array of second storage devices to compactly couple thereto, where the transverse dimension/size of each individual space allocated for coupling is smaller than the transverse dimension of the first storage carrier. The interposer assembly is positioned in a space of the first storage carrier that is physically proximate to an opposing connector and an adjacent connector of the connector array when the first storage carrier is placed for coupling the first storage device to the opposing connector. The interposer assembly is disposed between the first storage device and the opposing connector to cause the first storage device to be displaced laterally away from the adjacent connector while allowing the first storage device to be physically and communicatively coupled to the opposing connector without causing any physical contact with the adjacent connector.

According to yet another aspect of the disclosure, disclosed is a method of providing a common platform in an information handling system (IHS) to simultaneously support a first storage device and a second storage device with the transverse dimension of the first storage device being larger than the corresponding transverse dimension of the second storage device. The method comprises coupling an interposer assembly to the first storage device disposed in a first storage carrier to form a first storage assembly. The method further comprises inserting the first storage assembly into the IHS towards an array of connectors, so that the interposer assembly is positioned in a space of the first storage carrier that is physically proximate to an opposing connector and at least one adjacent connector of the connector array. The array of connectors are configured to allow an array of second storage devices to compactly couple to individual connectors, but the transverse dimension of each individual space allocated for coupling is smaller than the transverse dimension of the first storage carrier. The interposer assembly is disposed between the first storage device and the opposing connector to cause the first storage device to be displaced laterally away from the adjacent connector while allowing the first storage device to be physically and communicatively coupled to the opposing connector without causing any physical contact with the adjacent connector.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 provides a block diagram representation of an example information handling system within which certain aspects of the disclosure can be practiced, according to one embodiment;

FIG. 2 is a perspective view illustrating a non-volatile storage of an IHS according to one embodiment;

FIG. 3 is a plan view illustrating how a single density storage device can be coupled to a double density backplane by using an interposer assembly, according to one embodiment;

FIGS. 4A-4D are schematic diagrams illustrating an exemplary sequence of how an interposer assembly becomes disposed between a single density storage device and a double density backplane connector on a double density backplane, according to one or more embodiments;

FIG. 5A is an elevated view taken in front of a storage bay, illustrating how existing double dense guiding features in the storage bay are cleared by single density storage devices inserted into the storage bay, according to one or more embodiments;

FIG. 5B is a perspective view illustrating exemplary guiding configurations incorporated into a single density storage carrier, according to one embodiment;

FIG. 6 is a flow diagram illustrating a method of modifying a single density storage device and storage carrier so as to facilitate provision of a common platform in an IHS to support storage devices of double and single densities, according to one or more embodiments; and

FIGS. 7A and 7B are schematics illustrating how a single density storage device can be coupled to an array of double density panel-mount connectors by using an interposer assembly, according to one embodiment.

### DETAILED DESCRIPTION

The illustrative embodiments provide a storage assembly, system and method for providing a common platform in an information handling system (IHS) to support storage devices of different transverse dimensions. The storage assembly comprises a first storage device compactly disposed in a first storage carrier. The first storage device has a transverse dimension (e.g., a width) that is larger than that of second storage devices specifically designed to be compactly coupled to the common platform via an array of connectors. The storage device further comprises an interposer assembly coupled to a data interface of the first storage device. When the first storage carrier is placed for coupling the first storage device to an opposing connector of the array of connectors, the interposer assembly is disposed between the first storage device and the opposing connector to cause the first storage device to be displaced laterally away from an adjacent connector while coupling the first storage device to the opposing connector.

In the following detailed description of exemplary embodiments of the disclosure, specific exemplary embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

Those of ordinary skill in the art will appreciate that the hardware components and basic configuration depicted in the following figures may vary. For example, the illustrative components within information handling system 100 and features of a single density storage carrier 211 are not intended to be exhaustive, but rather are representative to highlight essential components that are utilized to implement the present disclosure. For example, other devices/components may be used in addition to or in place of the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

Various aspects of the disclosure are described from the perspective of an information handling system. For purposes of this disclosure, an information handling system, such as information handling system 100, may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a handheld device, personal computer, a server, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

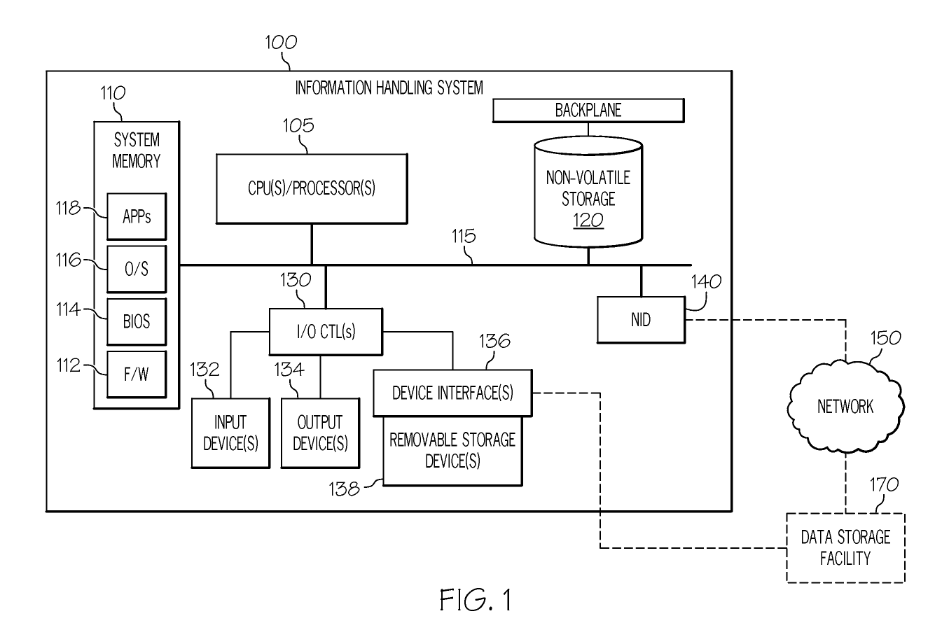

With reference now to the figures, and beginning with FIG. 1, there is depicted a block diagram representation of an example information handling system 100, within which one or more of the described features of the various embodiments of the disclosure can be implemented. Information handling system 100 includes at least one central processing unit (CPU) or processor 105 coupled to system memory 110 via system interconnect 115. System interconnect 115 can be interchangeably referred to as a system bus, in one or more embodiments. Also coupled to system interconnect 115 is nonvolatile storage (e.g., NVRAM) 120. According to one aspect of the disclosure, NVRAM 120 can include an array of hard disk drives (HDDs) communicatively coupled to a backplane via an array of backplane connectors deployed on the backplane. One or more software and/or firmware modules and one or more sets of data can be stored in NVRAM 120. These one or more software and/or firmware modules can be loaded into system memory 110 during operation of information handling system 100. Specifically, in one embodiment, system memory 110 can include therein a plurality of such modules, including one or more of firmware (F/W) 112, basic input/output system (BIOS) 114, operating system (0/S) 116, and application(s) 118. These software and/or firmware modules have varying functionality when their corresponding program code is executed by CPU 105 or secondary processing devices within information handling system 100.

Information handling system 100 further includes one or more input/output (I/O) controllers 130 which support connection by and processing of signals from one or more connected input device(s) 132, such as a keyboard, mouse, touch screen, or microphone. I/O controllers 130 also support connection to and forwarding of output signals to one or more connected output devices 134, such as a monitor or display device or audio speaker(s). Additionally, in one or more embodiments, one or more device interfaces 136, such as an optical reader, a universal serial bus (USB), a card reader, Personal Computer Memory Card International Association (PCMIA) slot, and/or a high-definition multimedia interface (HDMI), can be associated with IHS 100. Device interface(s) 136 can be utilized to enable data to be read from or stored to corresponding removal storage device(s) 138, such as a compact disk (CD), digital video disk (DVD), flash drive, or flash memory card. In one or more embodiments, device interfaces 136 can further include General Purpose I/O interfaces such as I²C, SMBus, and peripheral component interconnect (PCI) buses.

Information handling system 100 comprises a network interface device (NID) 140. NID 140 enables information handling system 100 and/or components within information handling system 100 to communicate and/or interface with other devices, services, and components that are located external to information handling system 100. These devices, services, and components can interface with information handling system 100 via an external network, such as example network 150, using one or more communication protocols. Network 150 can be a local area network, wide area network, personal area network, and the like, and the connection to and/or between network 150 and IHS 100 can be wired or wireless or a combination thereof. For purposes of discussion, network 150 is indicated as a single collective component for simplicity. However, it is appreciated that network 150 can comprise one or more direct connections to other devices as well as a more complex set of interconnections as can exist within a wide area network, such as the Internet.

In the illustrative embodiment, network 150 also provides access to data storage facility 170, which can include a plurality of physical disks or other storage media. In an alternate embodiment, and as represented by the second set of dashed interconnecting lines, data storage facility 170 can be directly connected to IHS 100 as an external storage device.

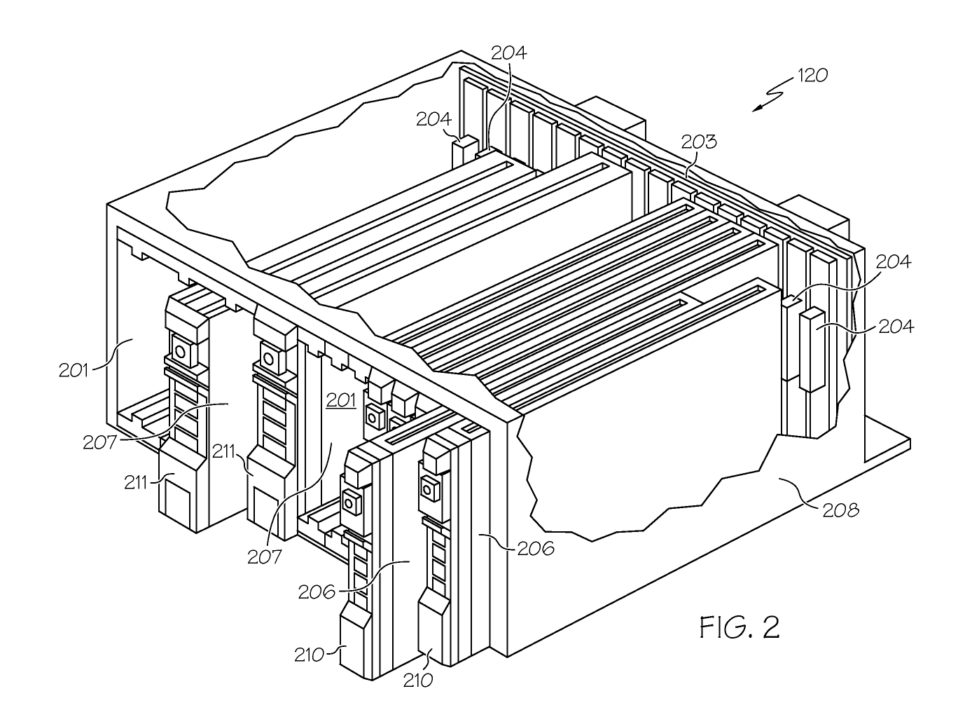

FIG. 2 is a perspective view illustrating an exemplary configuration of non-volatile storage 120 of IHS 100 in accordance with one embodiment of the disclosure. Non-volatile storage 120 is housed in chassis 208. Non-volatile storage 120 includes a double density backplane 203, on which an array of double density backplane connectors 204 are deployed. The backplane connectors are configured for coupling an array of double density storage devices 206 to the double density backplane 203. Under this double density configuration, adjacent double density backplane connectors 204 are compactly spaced in accordance with the width of a double density storage device 206. According to this embodiment, each individual double density backplane connector 204 can be an SAS connector capable of coupling an SSD to backplane 203.

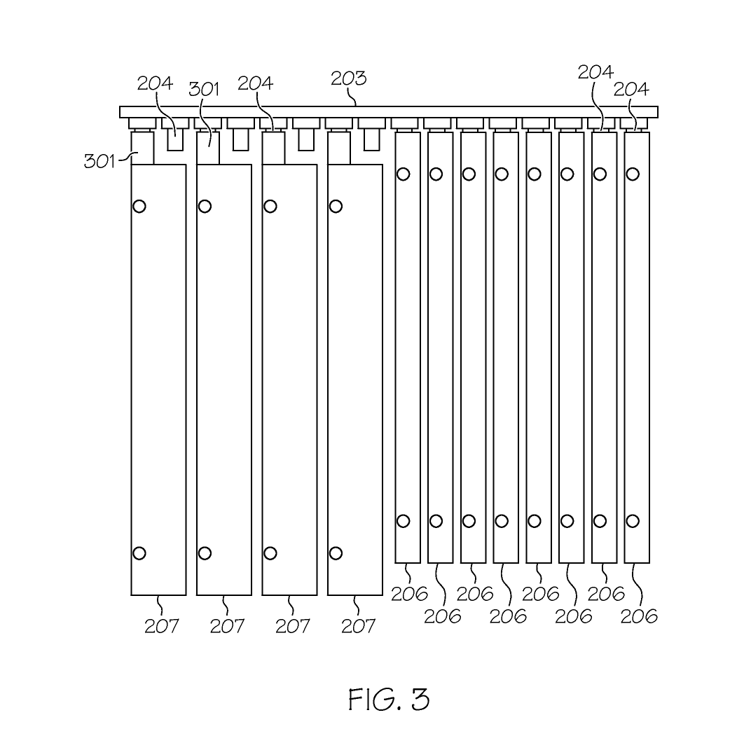

Non-volatile storage 120 also includes storage bay 201 configured for housing both double density storage carriers 210 (in each of which a double density storage device 206 is compactly disposed) and single density storage carriers 211 (in each of which a single density storage device 207 is compactly disposed). According to one aspect of the disclosure and as described herein, a single density storage device 207 is disposed in a single density storage carrier 211 that is approximately double the width of a double density storage carrier 210 in which a double density storage device is housed/disposed. According to the described embodiments, a double density storage device 206 can be a 7 mm 2.5″ SSD (which is typically 7.5 mm or less in width or thickness) while a single density storage device 207 can be a 15 mm 2.5″ SSD, where the label “7 mm” and the label “15 mm” represent the respective approximate widths of the storage device and/or the storage carriers. Within the description, reference is made to a transverse dimension and/or width of the storage devices and/or the storage carriers. These references to transverse dimension and width describe the dimension of the drives/carriers that extend from the left edge to the right edge as shown in FIGS. 3, 4D, and 5A. Also, within the industry, the terms “single density” and “double density” refer to the fact that the smaller width (7.5 mm or less) storage devices can contain a same amount or greater storage capacity than the wider (15 mm) storage devices (which are referred to as single density storage devices) contain. The actual storage capacity of the devices themselves is not however determinative of the use of an interposer assembly (as will be described in detail below), which can be utilized for any capacity storage device that is housed within a casing whose width is larger than the normal storage device width supported by the double density backplane. It is further appreciated that while the backplane and/or array of connectors are described as being configured with the connectors in a lateral side-by-side orientation, the functionality provided by the disclosure is also applicable to a vertical top-bottom orientation of connectors, where the different transverse dimensions of the first storage device and the second storage device refer to the vertical length of the drives, rather than the horizontal width thereof.

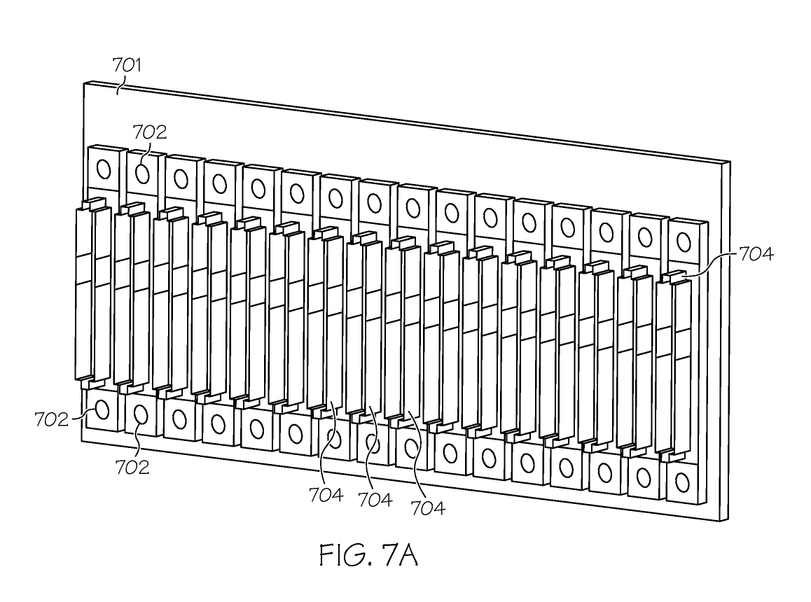

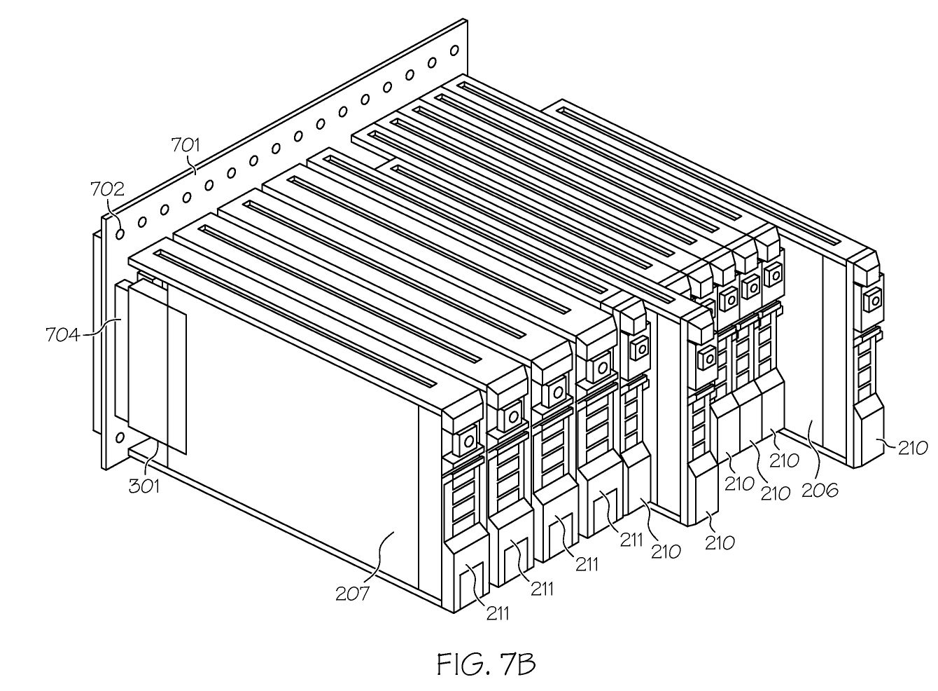

FIG. 3 is a plan view illustrating how a single density storage device 207 is communicatively coupled to an opposing double density backplane connector 204 of double density backplane 203, without abutting one or more adjacent double density backplane connectors 204, in accordance with one embodiment. Referring to FIG. 3, an interposer assembly 301 is disposed between the data interface of a single density storage device 207 and an opposing double density backplane connector 204 (or a panel mount connector, as will be described in detail below with reference to FIGS. 7A-7B) to cause the single density storage device 207 to be displaced laterally away from backplane 203. The interposer assembly 301 is disposed in such an orientation that its female connector at one end detachably mates with the opposing male double density backplane connector 204 and its male connector at the opposing end detachably mates with a female connector (i.e., the data interface) of the single density storage device 207.

With this configuration, the interposer assembly 301 routes data and/or signals being communicated between the opposing double density backplane connector 204 and the single density storage device 207, while creating an amount of separation distance from the closest edge/surface of the storage device 207 to an adjacent double density backplane connector 204, which abuts into the space behind the single density storage device 207. This separation distance prevents the single density storage device 207 from coming in contact with the adjacent double density backplane connector 204. This configuration also enables the single density storage device 207 to be physically and communicatively coupled to the double density backplane 203 via the opposing double density backplane connector 204. Thus, a common platform is realized, which, in this example, can simultaneously support storage devices of different transverse dimensions—namely, single density storage devices 207 and double density storage devices 206. As illustrated, eight double density storage devices 206 dock directly into the double density backplane 203, without requiring an interposer assembly. The example double density backplane 203 provides sixteen double density backplane connectors, and can thus support connection of up to sixteen double density storage devices 206 or eight single density storage devices 207. While FIG. 3 illustrates concurrent connection of eight double density storage devices 206 and four single density storage devices 207, it is appreciated that different combinations of double density storage devices 206 and single density storage devices 207 can be supported by the backplane, including having only one type of storage devices connected thereto.

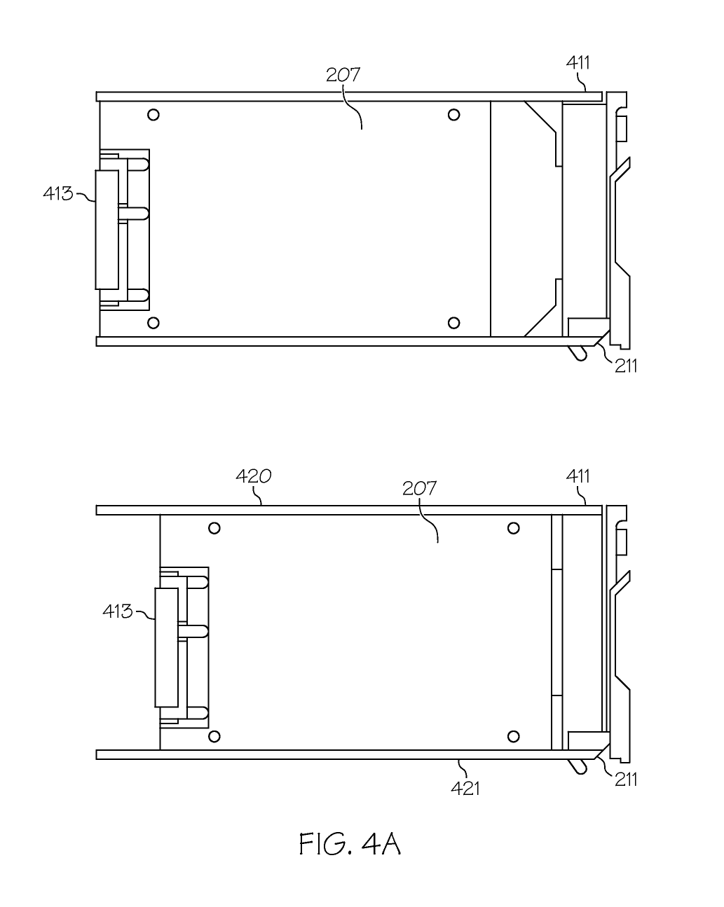

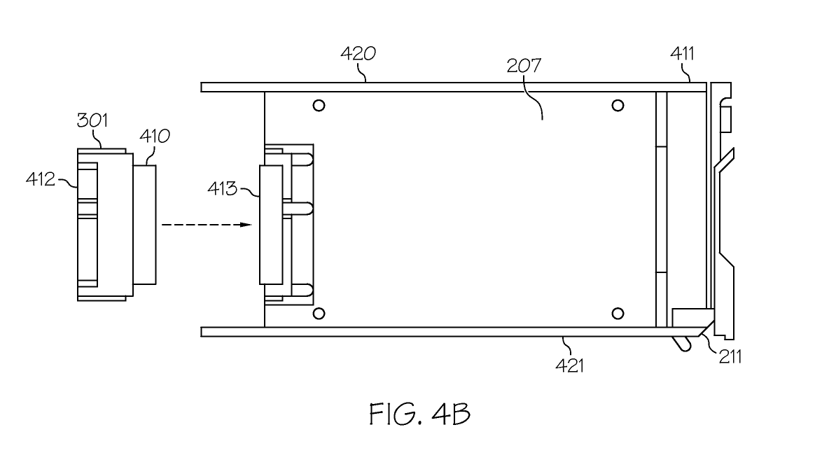

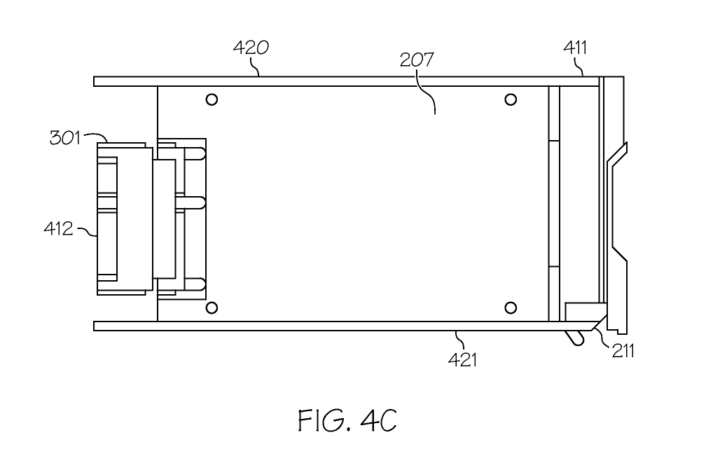

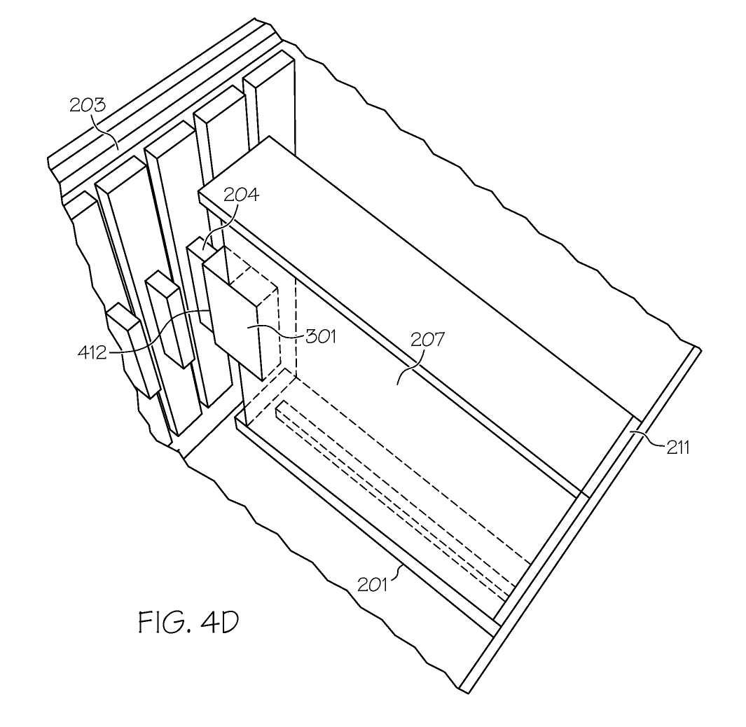

FIGS. 4A-4D are schematic diagrams illustrating an exemplary sequence of how an interposer assembly 301 can be mated/disposed between a single density storage device 207 and a double density backplane connector 204 on double density backplane 203 (as shown in FIG. 3) according to one or more embodiments.

FIG. 4A shows two schematic diagrams illustrating how a single density storage device 207 is switched from a first configuration to a second configuration when disposed in the single density storage carrier 211 as part of the exemplary sequence.

Referring to the top diagram of FIG. 4A, the single density storage device 207 is shown securely disposed in the single density storage carrier 211 according to a first configuration, which can be used to directly dock the single density storage device 207 into a single density backplane (not shown). As illustrated in the top diagram, with the first configuration, not much open space is left at the front portion of the single density storage device carrier 211 while there is unoccupied space at handle section 411 of the back portion of the single density storage carrier 211.

Referring to the bottom diagram of FIG. 4A, the single density storage device 207 is shown disposed closer towards handle section 411 of the single density storage carrier 211. The single density storage device 207 is moved backwards to occupy a portion of the previously unoccupied space, the single density storage device 207 is then secured in that location to provide a second configuration. As illustrated in the bottom diagram, with the second configuration, a larger open space is left at the front portion of the single density storage device carrier 211. According to one aspect of the disclosure, this available space can be utilized to determine the relative size of the interposer assembly, as the interposer assembly is designed to allow for the spacing of the storage device away from the adjacent connectors, while maintaining the same overall dimensions of the single density storage carrier 211.

FIG. 4B is a schematic diagram showing an exemplary technique of coupling the interposer assembly 301 to the single density storage device 207 disposed in the single density storage carrier 211 according to the second configuration illustrated in FIG. 4A. Male connector 410 of the interposer assembly 301 mates with a female connector 413 (i.e., the data interface) of the single density storage device 207. After the mating operation, referring to the schematic diagram shown in FIG. 4C, the interposer assembly 301 is coupled to the single density storage device 207 at one end of the interposer assembly 301 (in the space provided at the front portion of the single density storage carrier 211), leaving female connector 412 at the opposing end of the interposer assembly 301 available for mating with a male head of the opposing double density backplane connector 204 on double density backplane 203. The interposer assembly 301 may be coupled to the single density storage device 207 either before or after the single density storage device 207 is switched from the first configuration to the second configuration, as illustrated by FIG. 4A. Also, according to one embodiment, the interposer assembly 301 can be attached to or via a connecting affordance of the storage carrier 301 and/or of the storage device 207 in order to prevent the interposer assembly from remaining mated to the backplane connector when the drive assembly (i.e., the storage carrier 301 with the storage device 207) is removed from being connected to the backplane. As one example, the interposer assembly 301 and/or storage carrier 301 and/or of the storage device 207 can have a standard detent feature that accomplishes this fixed connection.

FIG. 4D is a schematic diagram illustrating how the interposer assembly 301 is disposed between the single density storage device 207 and a double density backplane connector 204 (on double density backplane 203) when the coupling assembly illustrated in FIG. 4B is inserted into storage bay 201. With the coupling assembly shown in FIG. 4B, as the single density storage carrier 211 is inserted into storage bay 201 towards double density backplane 203, female connector 412 of the interposer assembly 301 mates with a male double density backplane connector 204, resulting in the interposer assembly 301 disposed between the single density storage device 207 (disposed in the single density storage carrier 211) and the double density backplane connector 204, as also shown in FIG. 3.

As a skilled artisan appreciates, although FIGS. 3 and 4A-4D illustrate one or more embodiments where a double density backplane connector 204 is a male connector, for different situations where, e.g., a double density backplane connector 204 is a female connector, changes can be made to achieve same or similar objectives without departing form the scope and spirit of the disclosure. For example, if a double density backplane connector 204 is a female connector, the interposer assembly 301 may have a male connector 412 (rather than a female connector 412) at one end to detachably mate with the corresponding female double density backplane connector 204 and a female connector 410 at the opposing end to detachably mate with a male connector 413 (i.e., data interface) of the single density storage device 207.

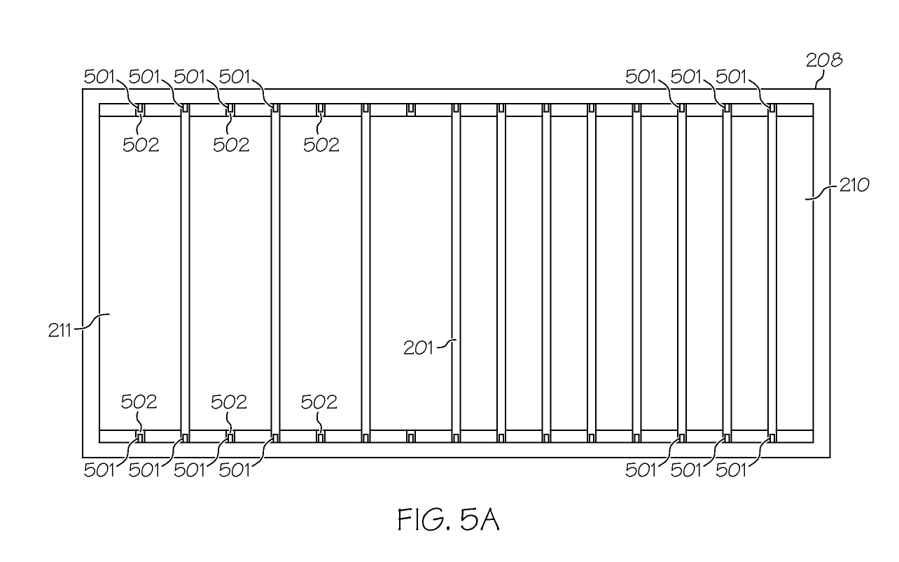

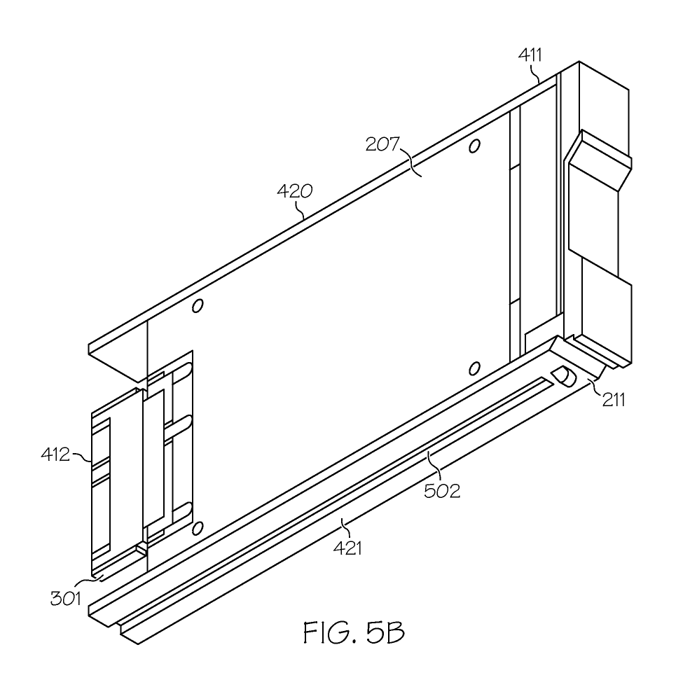

FIGS. 5A and 5B further illustrate one embodiment which incorporates guiding features to facilitate provision of a common platform supporting storage devices of different transverse dimensions (e.g., storage devices of different widths, such as double and single density devices). Referring to FIG. 5A, which is an elevated view taken in front of storage bay 201, there are illustrated at the top surface and bottom surface of storage bay 201 a series of opposing top and bottom pairs of double dense guiding features 501. Each opposing top and bottom pair is used for guiding a double density storage carrier 210 (in which a double density storage device 206 is disposed) to directly couple the double density storage device 206 to double density backplane 203.

Compared to a storage bay of similar size (not shown) of an IHS 100 configured for coupling an array of single density storage devices 207 to a single density backplane having deployed thereon an array of single density backplane connectors, storage bay 201 is provided twice as many guiding features 501. This is due to the fact that a double density storage device 206, as defined herein and in the industry, is approximately half the width of a single density storage device 207. As a result, there are approximately twice as many backplane connectors 204 deployed on a similarly-dimensioned double density backplane 203 in storage bay 201 as the number of backplane connectors that can be deployed on the single density backplane.

FIG. 5B is a perspective view illustrating a guiding configuration incorporated on guide rail 421 of a single density storage carrier 211 to enable clearance of a double dense guiding feature 501 when the single density storage carrier 211 is inserted into storage bay 201. Referring to FIG. 5B, a slot 502 is provided in or near the middle of guide rail 421 of the single density storage carrier 211. A slot 502 may also be provided on the other guide rail 420 of the single density storage carrier 211. Referring back to FIG. 5A, as the single density storage carrier 211 is inserted into storage bay 201, protrusions of a vertical pair of double dense guiding features 501 pre-disposed in storage bay 201 are received into corresponding slots 502 of the pair of guide rails 420 and 421, thereby clearing the vertical pair of double dense guiding features 501.

With this configuration, the cleared pair of guiding features 501 of storage bay 201 engages with the storage carrier 211, thereby helping to secure the insertion of the single density storage carrier 211 into storage bay 201. Further, one or both vertical pairs of double dense guiding features 501 that are adjacent to the cleared pair of guiding features—which usually guide insertions of double density storage carriers —can now be utilized to guide the insertion of the single density storage carrier 211.

In an alternate embodiment, moveable double dense guiding features 501 in storage bay 201 may be provided to facilitate provision of a common platform supporting storage devices of double and single densities. In one or more examples, intermediate double dense guiding features 501, each of which is moveable or removable, are each disposed in a vertical plane in-between the two vertical planes defining the vertical boundaries of a space allocated in storage bay 201 for insertion of a single density storage device 207. For the embodiment implementing the moveable guiding feature, as a single density storage device 207 is being inserted into an allocated space, the corresponding vertical pair of intermediate double dense guiding features 501 are forced to move away (e.g. backwards) into an unoccupied space of storage bay 201, thereby facilitating the single density storage device 207 to be fully inserted into storage bay 201.

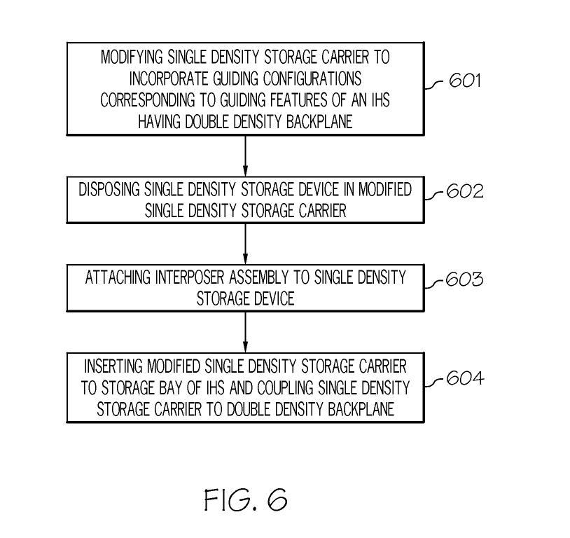

FIG. 6 is a flow diagram illustrating a method of enabling a common platform in an IHS to simultaneously support a first storage device and a second storage device with a transverse dimension of the first storage device being larger than a corresponding transverse dimension of the second storage device. Aspects of the method involve modifying a single density storage carrier 211 in such a manner that the modified single density storage carrier 211 is adapted to facilitate provision of a common platform in an IHS 100 to support storage devices of double and single densities, according to one or more embodiments of the disclosure.

Referring to FIG. 6, in step 601, a single density storage carrier 211 is modified to incorporate one or more guiding configurations adapted to enable the single density storage carrier 211 to clear one or more guiding features 501 pre-disposed in storage bay 201 of an IHS 100 when the single density storage carrier 211 is inserted into storage bay 201. Specifically, the carrier 211 is provided with a guide rail that includes the guiding configuration adapted to clear a guiding feature that is disposed in the storage bay. For example, the single density storage carrier 211 may be modified to have a slot 502 on each of its guide rails 420 and 421, as shown in FIG. 5B. As exemplified in FIG. 5A, with these guiding configurations, when the modified single density storage carrier 211 is inserted into storage bay 201 towards double density backplane 203, a corresponding vertical pair of guiding features 501 are cleared as protrusions of guiding features 501 are received into slots 502 on guide rails 420 and 421 thereof.

In step 602, the single density storage device 207 is disposed in the modified single density storage carrier 211 according to, for example, the second configuration illustrated in FIG. 4A. In step 603, an interposer assembly 301 is provided for coupling to the single density storage device 207 disposed in the single density storage carrier 211, as illustrated in FIG. 4C. The coupling of the interposer assembly 301 to the single density storage device 207 may be performed either before or after the single density storage device 207 is disposed in the modified single density storage carrier 211.

In step 604, the modified single density storage carrier 211 is inserted into storage bay 201, which is partly enabled by the clearance of a vertical pair of guiding features 501. The single density storage carrier 211 is inserted at an orientation of the carrier at which the guiding feature disposed in the storage bay is cleared as a result of the at least one protrusion of the guiding features being received into the slot of/on the guiding rail. The insertion causes the interposer assembly to be disposed between a double density backplane connector 204 and the single density storage device 207, as illustrated in FIG. 3. This configuration, as noted above, enables the data interface of the single density storage device 207 to be physically and communicatively coupled to double density backplane 203, thus allowing the double density backplane 203 to support the single density storage device 207 in addition to supporting double density storage devices 206.

FIGS. 7A-B are schematic diagrams for illustrating how a common platform is provided to support storage devices of different transverse dimensions in an IHS where an array of double density panel-mount connectors are used to connect storage devices, in accordance with one embodiment. Referring to FIGS. 7A-B, in place of using the previously described double density backplane 203 and an array of double density backplane connectors 204 deployed thereon, an IHS 100 (not shown) uses a front panel 701 and an array of double density panel-mount connectors 704 (which may be female connectors as illustrated in FIG. 7A) to connect the two types of storage devices of different transverse dimensions. Front panel 701 is configured to vertically mount an array of double density panel-mount connectors 704, which are mounted via an array of vertical pairs of screw holes 702. As illustrated in FIG. 7B, in this embodiment, similar to one or more embodiments illustrated above in FIGS. 2-6 (where a double density backplane 203 and an array of double density backplane connectors 204 deployed thereon are used to connect an array of storage devices of different transverse dimensions), a single density storage device 207 (disposed in a single density storage carrier 211) is physically and communicatively coupled to a double density panel-mount connector 704 through an intermediate interposer assembly 301. The interposer assembly 301 has a male connector (not shown) to mate to the female double density panel-mount connector 704.

With this configuration, as shown in FIG. 7B, an array of sixteen double density panel-mount connectors 704 are able to simultaneously support four single density storage devices 207 and eight double density storage devices 206. Thus, methods, apparatuses (e.g. storage assemblies), techniques, and/or sequences illustrated above in FIGS. 2-6 can be equally or similarly applied to a configuration where an array of double density panel-mount connectors 704 are used to connect storage devices, so as to provide a common platform supporting storage devices of different transverse dimensions.

With the embodiments illustrated above, an IHS 100 is able to provide a common platform supporting different combinations of double density storage devices 206 and single density storage devices 207, which are storage devices of different transverse dimensions (widths). Further, an IHS 100 is obviated of any need to have in place an additional backplane separately configured for supporting single density storage devices 207 as well as any need to add complexity to the existing backplane and chassis.

According to one embodiment, the storage assembly comprises: a first storage device having a data interface for coupling the first storage device to an opposing connector within an array of connectors of an information handling system; and an interposer assembly coupled to the data interface of the first storage device such that the interposer assembly is disposed between and enables coupling of the first storage device to the opposing connector when the first storage device is positioned for coupling to the opposing connector. The interposer assembly causes the first storage device to be displaced laterally away from an adjacent connector of the array of connectors without causing any physical contact with the adjacent connector, while allowing the first storage device to be physically and communicatively coupled to the opposing connector. Also, the first storage device has a transverse dimension which is larger than a corresponding transverse dimension of second storage devices that are specifically designed to compactly couple to adjacent connectors of the array of connectors. Accordingly, a cross spacing available for directly coupling to the adjacent connectors is smaller than the transverse dimension of the first storage device.

According to one aspect, the storage assembly further comprises: a first storage carrier within which the first storage device is physically secured at a first position that provides sufficient spacing at a coupling end of the first storage device for coupling the interposer assembly to the data interface of the first storage device without extending an overall length of the storage assembly. The interposer assembly is positioned in a connecting end of the first storage carrier that is physically proximate to an opposing connector and an adjacent backplane connector array when the first storage carrier is disposed for coupling of the first storage device to the opposing connector. Also, the connecting end of the storage assembly has a corresponding transverse dimension that is substantially close to the transverse dimension of the first storage device. The array of connectors are physically configured to allow an array of second storage devices to compactly couple thereto such that the transverse dimension of each individual space allocated between adjacent connectors is smaller than the transverse dimension of the first storage carrier. In one or more embodiments, the transverse dimension of the first storage device is larger than the corresponding transverse dimension of the second storage devices by a proportional size that allows each first storage device to extend across at least one adjacent connector, while coupled to the opposing connector.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof.

As one example, with respect to guiding configurations, a skilled artisan appreciates that there can be various guiding configurations incorporated into a single density device carrier 211 without departing from the scope and spirit of the present invention. For instance, instead of incorporating into a single density storage carrier 211 a slot 502 on either or both guide rails 420 and 421, a groove, or a combination of grooves and slots, may be incorporated into a single density storage carrier 211 for clearing guiding features 501 of storage bay 201. Further, depending upon relative locations of guiding features 501 pre-disposed in storage bay 501 and/or characteristics of guiding features 501, various guiding configurations may be incorporated into a single density storage carrier 211 to adapt the single density storage carrier 211 to guiding features 501 accordingly.

As another example, although the exemplary embodiments are directed to providing a common platform supporting storage devices having different widths (namely, double density storage devices and single density storage devices), changes can be made to provide a similar common platform supporting devices of other different transverse dimensions, without departing from the scope and spirit of the disclosure.

As yet another example, although the exemplary embodiments described above are directed to an IHS 100 with a backplane (or a front panel) configured for coupling vertically inserted storage device carriers, similar embodiments can be provided to be directed to an IHS 100 with a backplane (or a front panel) configured for coupling horizontally inserted storage carriers, without departing from the scope and spirit of the disclosure.

Therefore, it is intended that the disclosure not be limited to the particular embodiments disclosed for carrying out this disclosure, but that the disclosure will include all embodiments falling within the scope of the appended claims.

What is claimed is:

1. A storage assembly comprising:
a first storage device having a data interface for coupling the first storage device to an opposing connector within an array of connectors of an information handling system; and
an interposer assembly coupled to the data interface of the first storage device such that the interposer assembly is disposed between and enables coupling of the first storage device to the opposing connector when the first storage device is positioned for coupling to the opposing connector, wherein the interposer assembly causes the first storage device to be displaced laterally away from an adjacent connector of the array of connectors without causing any physical contact with the adjacent connector, while allowing the first storage device to be physically and communicatively coupled to the opposing connector;
wherein the first storage device has a transverse dimension which is larger than a corresponding transverse dimension of second storage devices that are specifically designed to compactly couple to adjacent connectors of the array of connectors, wherein a cross spacing available for directly coupling to the adjacent connectors is smaller than the transverse dimension of the first storage device.

2. The storage assembly of claim 1, further comprising:
a first storage carrier within which the first storage device is physically secured at a first position that provides sufficient spacing at a coupling end of the first storage device for coupling the interposer assembly to the data interface of the first storage device without extending an overall length of the storage assembly;
wherein the interposer assembly is positioned in a connecting end of the first storage carrier that is physically proximate to the opposing connector and an adjacent connector of the connector array when the first storage carrier is disposed for coupling of the first storage device to the opposing connector;
wherein the connecting end of the storage assembly has a corresponding transverse dimension that is substantially close to the transverse dimension of the first storage device.

3. The storage assembly of claim 2, wherein:
the array of connectors are physically deployed on a backplane in a storage bay; and
the array of connectors are physically configured to allow an array of second storage devices to compactly couple thereto such that the transverse dimension of each individual space allocated between adjacent connectors is smaller than the transverse dimension of the first storage carrier.

4. The storage assembly of claim 3, wherein the first storage carrier comprises a guide rail having a guiding configuration adapted to clear a guiding feature disposed in the storage bay when the first storage carrier is inserted into the storage bay.

5. The storage assembly of claim 4, wherein the guiding configuration included in the guide rail of the first storage carrier comprises a slot.

6. The storage assembly of claim 4, wherein the guiding feature disposed in the storage bay is cleared as a result of at least one protrusion of the guiding feature being received into the slot of the guiding rail of the first storage carrier when the first storage carrier is inserted into the storage bay.

7. The storage assembly of claim 2, wherein each connector of the array of connectors is physically mounted on a panel.

8. The storage assembly of claim 1, wherein the transverse dimension of the first storage device is larger than the corresponding transverse dimension of the second storage devices by a proportional size that allows each first storage device to extend across at least one adjacent connector, while coupled to the opposing connector.

9. A system of providing a common platform in an information handling system (IHS) to simultaneously support a first storage device and a second storage device, where a transverse dimension of the first storage device is larger than the corresponding transverse dimension of the second storage device, the system comprising:
a first storage assembly comprising:
a first storage device compactly disposed in a first storage carrier; and
an interposer assembly coupled to a data interface of the first storage device; and
an array of connectors physically configured to allow an array of second storage devices to compactly couple thereto, wherein the transverse dimensional space corresponding to each connector for coupling thereto is smaller than the transverse dimension of the first storage carrier;
wherein the interposer assembly is positioned in a space of the first storage carrier that is physically proximate to an opposing connector and an adjacent connector of the connector array when the first storage carrier is placed to allow coupling of the first storage device to the opposing connector, and the interposer assembly is disposed between the first storage device and the opposing connector to cause the first storage device to be displaced laterally away from the adjacent connector while allowing the first storage device to be physically and communicatively coupled to the opposing connector without causing any physical contact with the adjacent connector.

10. The system of claim 9, wherein the array of connectors is physically deployed on a backplane in a storage bay.

11. The system of claim 10, wherein the first storage carrier comprises a guide rail having a guiding configuration adapted to clear a guiding feature disposed in the storage bay when the first storage carrier is inserted into the storage bay.

12. The system of claim 11, wherein the guiding configuration included in the guide rail of the first storage carrier comprises a slot.

13. The storage assembly of claim 11, wherein the guiding feature disposed in the storage bay is cleared as a result of at least one protrusion of the guiding feature being received into the slot of the guiding rail of the first storage carrier when the first storage carrier is inserted into the storage bay.

14. The system of claim 9, wherein the array of connectors are physically mounted on a panel.

15. The system of claim 9, wherein the transverse dimension of the first storage device is larger than the corresponding transverse dimension of the second storage devices by a proportional size that allows each first storage device to extend across at least one adjacent connector, while coupled to the opposing connector.

16. A method of enabling a common platform in an information handling system (IHS) to simultaneously support a first storage device and a second storage device with a transverse dimension of the first storage device being bigger than a corresponding transverse dimension of the second storage device, the method comprising:
providing an interposer assembly for coupling to a data interface of the first storage device form a first storage assembly; and
disposing the first storage device in a first storage carrier configured to be inserted into an IHS towards an array of connectors, wherein: the interposer assembly is positioned in a space of the first storage carrier that is physically proximate to an opposing connector and an adjacent connector of the array of connectors, the interposer assembly is disposed between and enables coupling of the first storage device to the opposing connector when the first storage device is positioned for coupling to the opposing connector, and the interposer assembly causes the first storage device to be displaced laterally away from an adjacent connector of the array of connectors without causing any physical contact with the adjacent connector, while allowing the first storage device to be physically and communicatively coupled to the opposing connector;
wherein the array of connectors is configured with spacing relative to the transverse dimension of a second storage device that allows an array of second storage devices to compactly couple to the individual connectors, and wherein each individual space allocated for coupling to a corresponding connector is smaller than the transverse dimension of the first storage carrier.

17. The method of claim 16, wherein the array of connectors is physically deployed on a backplane in a storage bay.

18. The method of claim 17, further comprising providing a guide rail on the first storage carrier, wherein the guide rail has a guiding configuration adapted to clear a guiding feature disposed in the storage bay when the first storage carrier is inserted into the storage bay.

19. The method of claim 17, wherein the guiding configuration includes at least one slot and the method further comprises inserting the first storage carrier into the storage bay at an orientation of the first storage carrier at which the guiding feature disposed in the storage bay is cleared as a result of at least one protrusion of the guiding feature being received into a slot of the guiding rail of the first storage carrier when the first storage carrier is inserted into the storage bay.

20. The method of claim 16, wherein the array of connectors is physically mounted on a panel.
